(19) United States
(12) Patent Application Publication
(10) Pub. No.: US 2005/0221800 A1
(43) Pub. Date: Oct. 6, 2005

(54) Method for remote lockdown of a mobile computer

(76) Inventors: Riley W. Jackson, Portland, OR (US); Jeffrey Huckins, Chandler, AZ (US); Muthu K. Kumar, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,008

(22) Filed: Mar. 31, 2004

(51) Int. Cl. H04M 1/66

(52) U.S. Cl. 455/411

(57) ABSTRACT

A method, machine readable medium, and system are disclosed. In one embodiment the method comprises sending a message on a wireless network to a mobile computer and disabling the mobile computer upon receipt of the message.

### FIELD OF THE INVENTION

The invention is related to mobile computers. More specifically, the invention relates to remotely locking down a mobile computer over a wireless network.

### BACKGROUND OF THE INVENTION

Mobile computers come in all sizes and shapes, from notebooks and laptops to handheld devices. People from business professionals to college students are realizing the benefits of having a computer that is mobile. For all the benefits that mobility creates, it also leads to certain mobile-specific problems. Mobile computer theft and loss is a problem facing many of today's mobile users. Often these computers hold valuable and confidential corporate and personal data that can be damaging if in the wrong hands. It is therefore important that a user can remotely lockdown (i.e. disable) his mobile computer when necessary. Thus, what is needed is an effective method to remotely lockdown a mobile computer to protect data located on the computer.

### BRIEF DESCRIPTION OF THE DRAWINGS

The present invention is illustrated by way of example and is not limited by the figures of the accompanying drawings, in which like references indicate similar elements, and in which:

FIG. 1 illustrates one embodiment of the environment in which the present invention operates.

FIG. 2 details a process for authenticating the lockdown message.

FIG. 3 illustrates a process for queuing and postponing the message until the mobile computer reacquires the wireless network.

FIG. 4 details a process for securing the mobile computer in one embodiment of the present invention.

### DETAILED DESCRIPTION

Embodiments of an effective method to remotely lockdown a mobile computer to protect data located on the computer are disclosed. In the following description, numerous specific details are set forth. However, it is understood that embodiments may be practiced without these specific details. In other instances, well-known elements, applications, and protocols have not been discussed in detail in order to avoid obscuring the present invention.

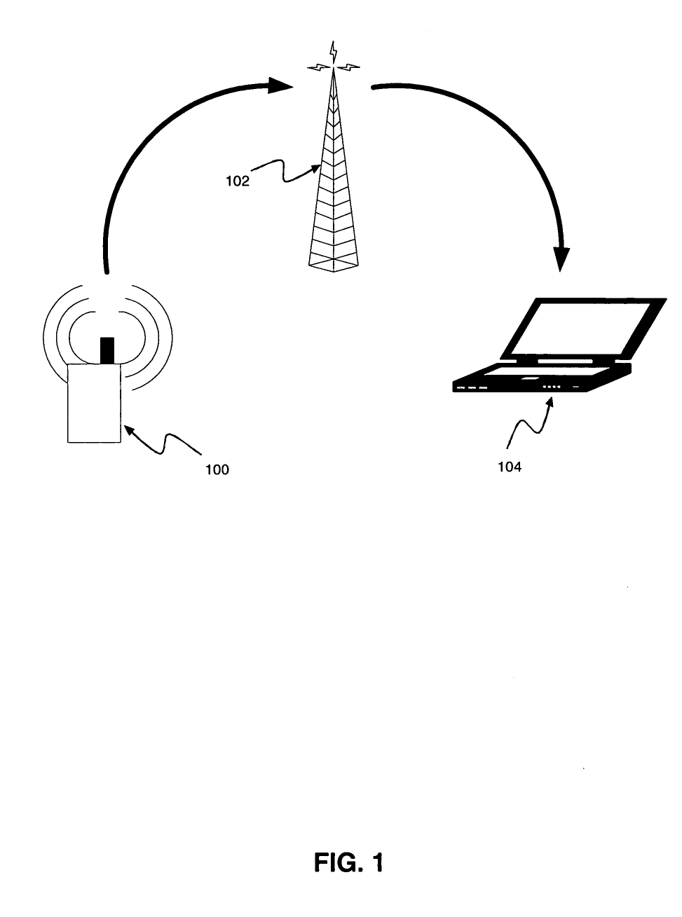

FIG. 1 illustrates one embodiment of the environment in which the present invention operates. A mobile computer 104 is lost or stolen. In one embodiment the mobile computer 104 is a handheld device (e.g. a Pocket PC, a smart phone, etc.). In another embodiment the mobile computer 104 is a notebook computer. In yet another embodiment the mobile computer 104 is any another given wireless device. The mobile computer 104 is connected to a wireless network 102. In different embodiments the wireless network 102 can utilize any given wireless protocol such as Global System for Mobile Communications (GSM), Code-Division Multiple Access (CDMA), Bluetooth, and 802.11 among others. In another embodiment the wireless network 102 can be a combination of more than one of these protocols. Once the owner of the mobile computer 104 realizes it is lost or stolen he sends a message to the computer to perform a lockdown. The message is sent from a device 100 that has access to the wireless network 102. In one embodiment the access device 100 is a cellular telephone that sends a Short Message Service (SMS) message to the mobile computer 104. In another embodiment the access device 100 is another mobile computer. In yet another embodiment the access device 100 is any device capable of sending a message over the wireless network 102. The mobile computer 104 performs a lockdown sequence that disables any further use once the message has been received.

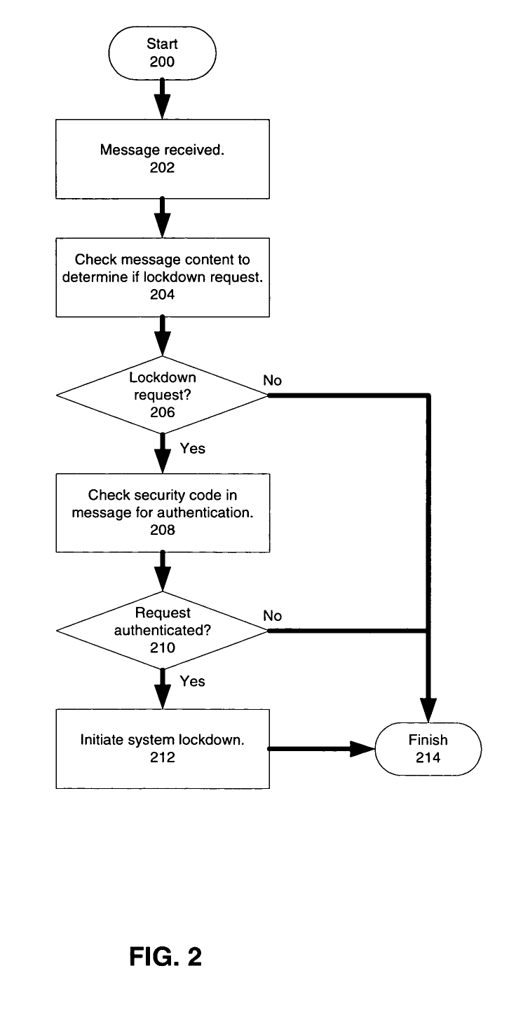

The message sent by the mobile computer user to the mobile computer should be authenticated. This prevents any person other than the owner of the mobile computer from disabling the mobile computer remotely. FIG. 2 details a process for authenticating the lockdown message. At the start 200 of the process the message is received on the wireless network 202. The content of the message is then checked to determine if a lockdown has been requested (204 and 206). If the message does not contain a lockdown request the process is finished 214. If the message does contain a lockdown request then the message is checked for authenticity. This check occurs by matching a specific security code stored within the mobile computer with the security code located in the body of the received message (208 and 210). If the security codes match the lockdown request has been authenticated the mobile computer initiates a system lockdown 212 and the process is finished 214. Otherwise, if the authentication fails the mobile computer does not initiate a system lockdown and the process is finished 216. In one embodiment, the received message is only the security code. In this case the lockdown request is granted automatically because the security code itself is an authenticated lockdown request. In one embodiment, the security code stored within the mobile computer can be set by the user upon initial setup of the computer such as any other password. In another embodiment, once the mobile computer has received and executed the lockdown procedure initiated by the user, the mobile computer can send a message back to the user to confirm the lockdown was received and successfully executed.

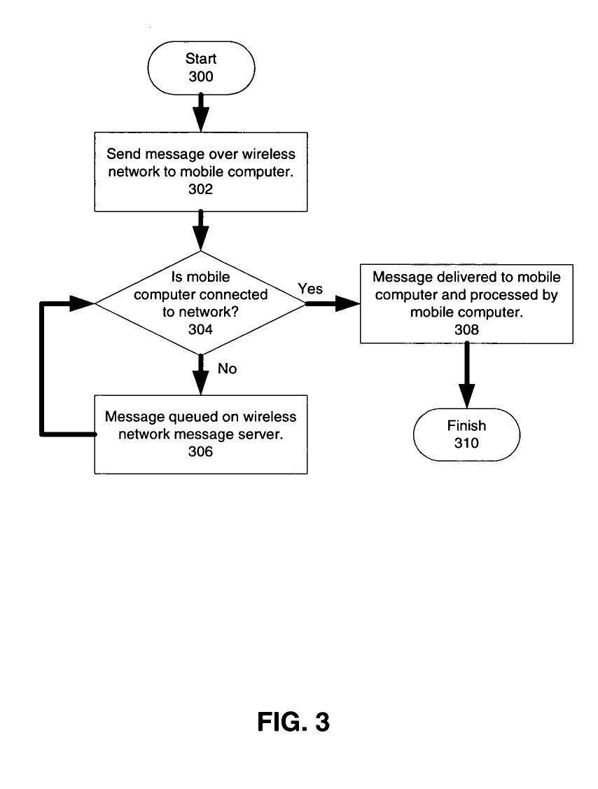

An issue can arise if the mobile computer is not connected to the wireless network during the broadcast of the lockdown request message. In this case the user is trying to send a lockdown request but the mobile computer is not receiving it for some reason. This lack of a wireless network connection can be due to a number of factors such as the mobile computer being in a powered down state, the mobile computer being in a standby state, and leaving the effective range of the wireless network among other reasons. FIG. 3 illustrates a process for queuing and postponing the message until the mobile computer reacquires the wireless network. At the start 300 of the process the lockdown message is sent over the wireless network to the mobile computer 302. Next, a check is made to determine if the mobile computer is connected to the wireless network 304. In one embodiment, this can be determined if the message is sent to the mobile computer but no acknowledgement is returned verifying the message has been received. In one embodiment, the mobile computer connectivity check occurs on a local or wide area network message server located separately on the wireless network. In another embodiment, the message server could be located within the user's device in which he sends the message to the mobile computer (i.e. a desktop computer, a second mobile computer, a cellular telephone, etc.). In different embodiments the network message server could attempt to deliver the message using any one or more of a number of message protocols such as SMS and POP3 among others. In further embodiments, the message server could be connected to the network using a wireless protocol such as GSM, CDMA, Bluetooth, 802.11b, 802.11a, or 802.11 g among others. If the message delivery fails, the message is queued on the message server 306. The next time the mobile computer connects to the network the message server delivers the queued message. Otherwise, if an acknowledgement is received that the mobile computer is connected to the wireless network the message is delivered to and processed by the mobile computer 308 and the process is complete 310.

Some mobile computers are in an always-on state such as cellular technology based computers or notebook computers with an always-on, separately operating wireless subsystem. In one embodiment if the mobile computer is on but outside of the effective range of the wireless network it will be constantly searching for the wireless network signal. Once the mobile computer finds the wireless network signal it will connect to the network and check for any incoming and queued messages. In another embodiment, if the mobile computer is powered off or in a suspend state and is subsequently powered on or woken up the mobile computer will connect to the network and check for any incoming and queued messages.

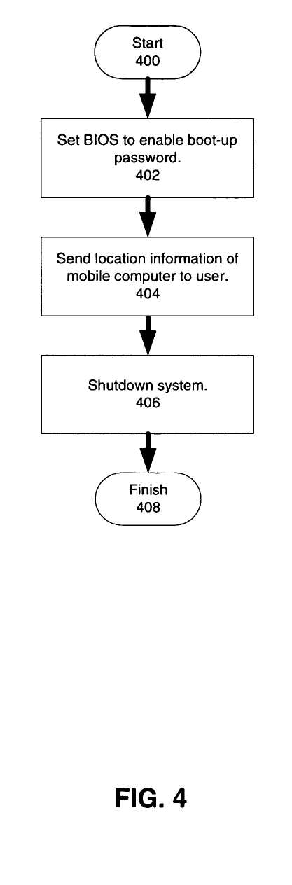

Once the mobile computer has received and authenticated the lockdown request the specific lockdown method must be performed to disable and secure the information within the computer. FIG. 4 details a process for securing the mobile computer in one embodiment of the present invention. At the start 400 of the process the BIOS is set to enable the boot-up password 402. In one embodiment this password can be similar or identical to the hard drive password that is set within the BIOS of many laptops. In another embodiment the password can be located further along during boot up and be stored with the mobile computer's operating system registry. Thus, subsequent to enabling this password check the user would need to provide the password to boot up the operating system on the mobile computer's hard drive. Otherwise a person would not be able to boot the computer to gain access to information stored in the computer. In one embodiment a global positioning system (GPS) within the mobile computer would allow for a pinpointed location. In this embodiment location information of the mobile computer is sent to the user who sent the lockdown message 404. Finally, the system initiates an immediate overriding shutdown sequence 406 and the process is finished 408. In one embodiment, the overriding shutdown sequence would include a mandatory and immediate system shutdown command in the operating system. In another embodiment, the overriding shutdown sequence would actually trigger a hardware reset, which would toggle the reset pin located in the hardware of the mobile computer. In this embodiment the entire operating system running on the mobile computer would be bypassed and an immediate reboot would take place regardless of the state of the operating system on the mobile computer. After the mobile computer has powered down the password would be required to boot into the operating system on any ensuing restart.

In one embodiment the lockdown message can relay different levels of severe disabling measures depending on the situation presented to the user. If the information is highly secretive and cannot afford to enter into other hands the shutdown sequence can include a formatting procedure to erase the hard drive or any other storage media located within the mobile computer. In another embodiment the user, upon retrieving his mobile computer sometime after initiating a lockdown sequence could disable the boot password within the OS after successfully entering the password. In yet another embodiment the lockdown sequence could automatically be disabled, along with the boot password requirement once the password was entered correctly once.

Thus, an effective method to remotely lockdown a mobile computer to protect data located on the computer is disclosed. These embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

1. A method, comprising:
sending a message on a wireless network to a mobile computer; and
disabling the mobile computer upon receipt of the message.

2. The method of claim 1, wherein sending a message on a wireless network to a mobile computer further comprises:
pre-setting and storing a security code on the mobile computer;
sending a security code message to the mobile computer using the wireless network; and
determining the authenticity of the sender of the message by comparing the sent security code message to the pre-set security code stored on the mobile computer.

3. The method of claim 1, wherein disabling the mobile computer upon receipt of the message further comprises:
initiating a system shutdown on the mobile computer once the message has been received; and
requiring a BIOS password to be provided prior to booting the operating system for any system reboot subsequent to the receipt of the message.

4. The method of claim 3, further comprising queuing the message if the mobile computer is unable to immediately receive the message.

5. The method of claim 4, further comprising receiving the queued message upon power up if the mobile computer was powered down when the message was received.

6. The method of claim 4, further comprising receiving the queued message upon waking if the mobile computer was in a suspended state when the message was received.

7. The method of claim 4, further comprising receiving the queued message upon entering the wireless network if the mobile computer was outside of the range of the wireless network when the message was received.

8. The method of claim 3, further comprising:
ascertaining the current location of the mobile computer upon receipt of the message; and
sending the location back to the originator of the message.

9. The method of claim 8, wherein ascertaining the location of the mobile computer further comprises receiving GPS location information on the mobile computer.

10. The method of claim 1, wherein disabling the mobile computer upon receipt of the wireless signal further comprises formatting a storage device on the mobile computer.

11. The method of claim 1, wherein the wireless network further comprises a cellular network.

12. The method of claim 1 further comprising sending a confirmation back to the message sender upon successfully disabling the wireless computer.

13. The method of claim 2 wherein the security code comprises a Short Message Service message.

14. The method of claim 4, wherein queuing the message further comprises storing the message on a message server located on the wireless network.

15. The method of claim 4, wherein queuing the message further comprises storing the message in an always-on wireless subsystem located within the wireless computer.

16. The method of claim 3, further comprising allowing the BIOS password requirement to be removed once a valid BIOS password has been given and the system has returned to normal operating state.

17. A machine readable medium having embodied thereon instructions, which when executed by a machine, causes the machine to perform a method comprising:
sending a message on a wireless network to a mobile computer; and
disabling the mobile computer upon receipt of the message.

18. The machine readable medium of claim 17 wherein sending a message on a wireless network to a mobile computer further comprises:
pre-setting and storing a security code on the mobile computer;
sending a security code message to the mobile computer using the wireless network; and
determining the authenticity of the sender of the message by comparing the sent security code message to the pre-set security code stored on the mobile computer.

19. The machine readable medium of claim 17 wherein disabling the mobile computer upon receipt of the message further comprises:
initiating a system shutdown on the mobile computer once the message has been received; and
requiring a BIOS password to be provided prior to booting the operating system for any system reboot subsequent to the receipt of the message.

20. The machine readable medium of claim 19, wherein the method further comprises queuing the message if the mobile computer is unable to immediately receive the message.

21. The machine readable medium of claim 19, wherein the method further comprises:
ascertaining the current location of the mobile computer upon receipt of the message; and
sending the location back to the originator of the message.

22. The machine readable medium of claim 17, wherein the method further comprises sending a confirmation back to the message sender upon successfully disabling the wireless computer.

23. A system, comprising:
a bus;
a processor coupled to the bus;
a network interface card coupled to the bus; and
memory coupled to the processor, the memory adapted for storing instructions, which upon execution by the processor sends a message on a wireless network to a mobile computer and disables the mobile computer upon receipt of the message.

24. The system of claim 23 wherein the system:
pre-sets and stores a security code on the mobile computer;
sends a security code message to the mobile computer using the wireless network; and
determines the authenticity of the sender of the message by comparing the sent security code message to the pre-set security code stored on the mobile computer.

25. The system of claim 23 wherein the system:
initiates a system shutdown on the mobile computer once the message has been received; and
requires a BIOS password to be provided prior to booting the operating system for any system reboot subsequent to the receipt of the message.

26. The system of claim 25, wherein the system queues the message if the mobile computer is unable to immediately receive the message.

27. The system of claim 25, wherein the system:
ascertains the current location of the mobile computer upon receipt of the message; and
sends the location back to the originator of the message.

28. The system of claim 23, wherein the system sends a confirmation back to the message sender upon successfully disabling the wireless computer.
